(19) United States
(12) Patent Application Publication
(10) Pub. No.: US 2018/0307342 A1
(43) Pub. Date: Oct. 25, 2018

(54) CHIP SEAL RING FOR CAPACITIVE TOUCH SENSING

(71) Applicant: QUALCOMM Incorporated, San Diego, CA (US)

(72) Inventors: Masoud Roham, San Diego, CA (US); Mishel Matloubian, San Diego, CA (US)

(21) Appl. No.: 15/491,877

(22) Filed: Apr. 19, 2017

(51) Int. Cl. G06F 3/044; G06K 9/00

(52) U.S. Cl. CPC G06F 3/044; G06K 9/0002

(57) ABSTRACT

This disclosure provides systems, methods and apparatus for capacitive touch sensing. In one aspect, a chip seal ring having an integrated capacitive sense plate is provided. In some implementations, a capacitance of the integrated sense plate to a finger may be used to detect the presence of the finger. In some implementations, a fringe capacitance of the seal ring sense plate to the finger is used to detect the presence of the finger. The chip may be sensor chip, for example, a fingerprint sensor chip, and may be implemented in an electronic device.

### TECHNICAL FIELD

This disclosure relates to capacitive touch sensors, and more specifically, to a capacitive touch sensor integrated into a seal ring of a chip.

### DESCRIPTION OF THE RELATED TECHNOLOGY

Ultrasonic sensor systems may use an ultrasonic transmitter to generate and send an ultrasonic wave through an ultrasonically transmissive medium or media and towards an object to be detected. The ultrasonic transmitter may be operatively coupled to an ultrasonic sensor array configured to detect portions of the ultrasonic wave that are reflected from the object. For example, in ultrasonic fingerprint sensors, an ultrasonic pulse may be produced by starting and stopping the transmitter during a short interval of time. At each material interface encountered by the ultrasonic pulse, a portion of the ultrasonic pulse may be reflected.

For example, in the context of an ultrasonic fingerprint sensor, the ultrasonic wave may travel through a platen on which an object such as a person's finger may be placed to obtain fingerprint image information. After passing through the platen, some portions of the ultrasonic wave may encounter skin that is in contact with the platen, e.g., fingerprint ridges, while other portions of the ultrasonic wave encounter air, e.g., valleys between adjacent ridges of a fingerprint, and may be reflected with different intensities back towards the ultrasonic sensor array. The reflected signals associated with the finger may be processed and converted to digital values representing the signal strengths of the reflected signals. When such reflected signals are collected over a distributed area, the digital values of such signals may be used to produce a graphical display of the signal strength over the distributed area, for example by converting the digital values to an image, thereby producing an image of the fingerprint. Thus, an ultrasonic sensor system may be used as a fingerprint sensor or other type of biometric scanner.

Capacitive fingerprint sensors also may be used to obtain fingerprint image information. In capacitive sensor systems, capacitive coupling between an electrode and a person's finger and between the electrode and another electrode can model a capacitive voltage divider and the voltage at the intermediate point may be “read out” and converted to a digital value that also may be used, in part, to produce an image of the fingerprint.

In comparison with ultrasonic fingerprint sensors, capacitive fingerprint sensors may be simpler to manufacture, and therefore, cost less than ultrasonic fingerprint sensors. Capacitive fingerprint sensors also may use lower power, operate faster, are more stable over a wider temperature range, and provide high-resolution fingerprint images which make matching (e.g., authenticating the fingerprint image) easier to implement with lower complexity algorithms and lower memory requirements. However, capacitive fingerprint sensors limit the choice of the platen, for example, to thin platens or non-metallic platens. Moreover, capacitive fingerprint sensors also may be more prone to “spoofing” using fake fingerprints, and may be less robust (e.g., sweat or lotion on a finger may disrupt the fingerprint imaging).

By contrast, ultrasonic fingerprint sensors may be compatible with more platens (e.g., thicker and metallic platens), are more robust (e.g., can provide a fingerprint image despite sweat, lotion, etc. on a finger), and are less prone to spoofing (e.g., by penetrating into live tissue and imaging inside the live tissue for additional security). However, ultrasonic fingerprint sensors may be more expensive to manufacture due to the use of piezoelectric materials, are more sensitive to temperature, take longer to generate a fingerprint image, and use more power.

Low cost and low power authenticating wake-up mechanisms are of interest in electronic devices. To conserve power, capacitive touch sensing may be used to detect the presence of a finger, with ultrasonic fingerprint detection used for qualification. However, integrating capacitive touch sensing with another sensor (such as an ultrasonic fingerprint detector) can require an additional sensing plate, which is costly and can complicate sensing.

### SUMMARY

The systems, methods and devices of this disclosure each have several innovative aspects, no single one of which is solely responsible for the desirable attributes disclosed herein.

One innovative aspect of the subject matter described in this disclosure may be implemented in a device. The device may include a platen and a chip, with the chip including a chip substrate including a first surface that includes a seal ring region and an active circuit region. A seal ring on the seal ring region may surround the active circuit region and include an inner ring and an outer ring. The inner ring may be electrically grounded and the outer ring may be electrically floating and include a capacitive sense plate.

The device may further include a controller configured to detect a capacitance between a finger on the platen and the capacitive sense plate. The detected capacitance may be a fringe capacitance or a direct capacitance. According to various implementations, the first surface of the chip substrate may face away from or toward the platen. In some implementations, the controller may be further configured to initiate an applications processor to obtain a fingerprint of the finger after the finger is detected.

In some implementations, the seal ring may further include an intermediate ring disposed between the inner ring and the outer ring. The intermediate ring may be configured to provide an active shield to the capacitive sense plate. In some implementations, an amplifier may be connected between the outer ring and the intermediate ring. In some examples, the amplifier may be a unity gain amplifier. In some implementations, the intermediate ring may form a C-shape or an L-shape around the outer ring.

In some implementations, the chip includes circuitry configured for imaging of a fingerprint. The circuitry may be configured for ultrasonic imaging of a fingerprint. In some implementations, the device further includes an ultrasonic transmitter disposed such that the chip is between the ultrasonic transmitter and the platen.

In some implementations, the outer ring is divided into a plurality of segments electrically isolated from each other with each of the plurality of segments including a capacitive sense plate. An intermediate ring may be disposed between the inner ring and the outer ring, with the intermediate ring divided into a plurality of segments electrically isolated from each other. Each of the plurality of segments of the intermediate ring may be configured to provide an active shield to a capacitive sense plate of the outer ring.

Another innovative aspect of the subject matter described in this disclosure may be implemented in a method. The method may include providing a device including a platen and a chip, with the chip including a chip substrate including a first surface that includes a seal ring region and an active circuit region. A seal ring on the seal ring region may surround the active circuit region and include an inner ring and an outer ring. The inner ring may be electrically grounded and the outer ring may be electrically floating and include a capacitive sense plate. The method may further include detecting a capacitance between a finger on the platen and the capacitive sense plate, determining that a finger has touched the platen based on the detected capacitance, and initializing an applications processor based on the determination. In some implementations the method may further include authenticating a fingerprint of the finger. In some implementations, the first surface may face away from the platen, and the detected capacitance may be a fringe capacitance.

Still another innovative aspect of the subject matter described in this disclosure may be implemented in a system. The system may include a platen, a chip, and a non-transitory computer readable medium storing instructions executable by one or more processors of a controller. The chip may include a chip substrate including a first surface that includes a seal ring region and an active circuit region, and a seal ring on the seal ring region. The seal ring may surround the active circuit region and include an inner ring and an outer ring. The inner ring may be electrically grounded and the outer ring may be electrically floating and include a capacitive sense plate. The instructions may include instructions for detecting a capacitance between a finger on the platen and the capacitive sense plate, instructions for determining that a finger has touched the platen based on the detected capacitance, and instructions for initializing an applications processor based on the determination.

The system may further include an intermediate ring disposed between the inner ring and the outer ring. The intermediate ring may be configured to provide an active shield to the capacitive sense plate. In some implementations, the instructions further include instructions for sending a drive signal to the active shield to maintain a constant potential difference between the capacitive sense plate and the active shield. In some implementations, the system includes an amplifier connected between the outer ring and the intermediate ring. The amplifier may be a unity gain amplifier.

Still another innovative aspect of the subject matter described in this disclosure may be implemented in a device including a platen; a chip, the chip including a chip substrate including a first surface that includes a seal ring region and an active circuit region, and a seal ring on the seal ring region. The seal ring may surround the active circuit region. The device may further include means for sensing a capacitance between the seal ring and an object on the platen. In some implementations, the seal ring includes an inner ring and an outer ring and the means for sensing a capacitance includes a capacitive sense plate formed by the outer ring. In some implementations, the device includes means for electrically shielding the capacitive sense plate from electromagnetic interference. The means for electrically shielding the capacitive sense plate from electromagnetic interference may include an intermediate ring between the outer ring and the inner ring.

### BRIEF DESCRIPTION OF THE DRAWINGS

Details of one or more implementations of the subject matter described in this specification are set forth in the accompanying drawings and the description below. Other features, aspects and advantages will become apparent from the description, the drawings and the claims. Note that the relative dimensions of the following figures may not be drawn to scale.

Like reference numbers and designations in the various drawings indicate like elements.

FIG. 1 shows a front view of a diagrammatic representation of an example mobile device that includes a capacitive touch sensor according to some implementations.

FIG. 2A shows a block diagram representation of components of an example sensing system according to some implementations.

FIG. 2B shows a block diagram representation of components of an example mobile device that includes the sensing system of FIG. 2A.

FIG. 3A shows a cross-sectional projection view of a diagrammatic representation of a portion of an example sensing system according to some implementations.

FIG. 3B shows a zoomed-in cross-sectional side view of the example sensing system of FIG. 3A according to some implementations.

FIG. 4 shows an example of a device including a fingerprint sensor capable of capacitive sensing.

FIG. 5 shows a cross-sectional schematic of an example of a portion of a device including a sensor chip seal ring having concentric rings.

FIG. 6 shows a cross-sectional schematic of an example of a portion of a device including a sensor chip seal ring including a capacitive sense plate and an active shield.

FIGS. 7-9 show examples of various arrangements of a sensor chip seal ring including a capacitive sense plate and an active shield.

FIGS. 10A and 10B show an example of a sensor including a platen, a silicon (Si) sensor chip substrate, and a chip seal ring.

FIG. 11 shows an example of a top view of a seal ring including a segmented outer ring and a segmented intermediate ring.

FIG. 12 shows an example of a flowchart for using a capacitive touch sensor to wake up an electronic device.

### DETAILED DESCRIPTION

The following description is directed to certain implementations for the purposes of describing the innovative aspects of this disclosure. However, a person having ordinary skill in the art will readily recognize that the teachings herein may be applied in a multitude of different ways. The described implementations may be implemented in any device, apparatus, or system for ultrasonic sensing. In addition, it is contemplated that the described implementations may be included in or associated with a variety of electronic devices such as, but not limited to: mobile telephones, multimedia Internet enabled cellular telephones, mobile television receivers, wireless devices, smartphones, smart cards, wearable devices such as bracelets, armbands, wristbands, rings, headband, patches, etc., Bluetooth® devices, personal data assistants (PDAs), wireless electronic mail receivers, hand-held or portable computers, netbooks, notebooks, smartbooks, tablet computers, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), mobile health devices, computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also may be used in applications such as, but not limited to, electronic switching devices, radio frequency filters, sensors, accelerometers, gyroscopes, motion-sensing devices, magnetometers, inertial components for consumer electronics, parts of consumer electronics products, steering wheels or other automobile parts, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Implementations of the subject matter described herein relate to a chip that has a seal ring, with the seal ring including a sense plate for capacitive touch detection. The chip may be sensor chip, for example, an ultrasonic fingerprint sensor chip. In some implementations, a capacitance of the seal ring sense plate to a finger may be used to detect the presence of the finger. In some implementations, a fringe capacitance of the seal ring sense plate to the finger is used to detect the presence of the finger. The chips may be implemented in electronic devices. In some implementations, detection of the presence of a finger may be used as a wake-up mechanism for an electronic device.

Particular implementations of the subject matter described in this disclosure may be implemented to realize one or more of the following potential advantages. By using an existing component of a sensor as a sense plate for capacitive touch detection, capacitive touch detection is provided without additional stack layers or footprint. Further, device assembly may be simplified and provided at reduced cost without the need for additional sense plate. Capacitive touch sensing may be performed with detection of direct capacitance or fringe capacitance, allowing the chip to be implemented with the seal ring facing toward or away from a platen of a device. This may provide design flexibility for sensor stacks. In some implementations, capacitive touch sensing using the capacitive sense plates described herein is a low cost and low power wake-up mechanism for electronic devices such mobile devices.

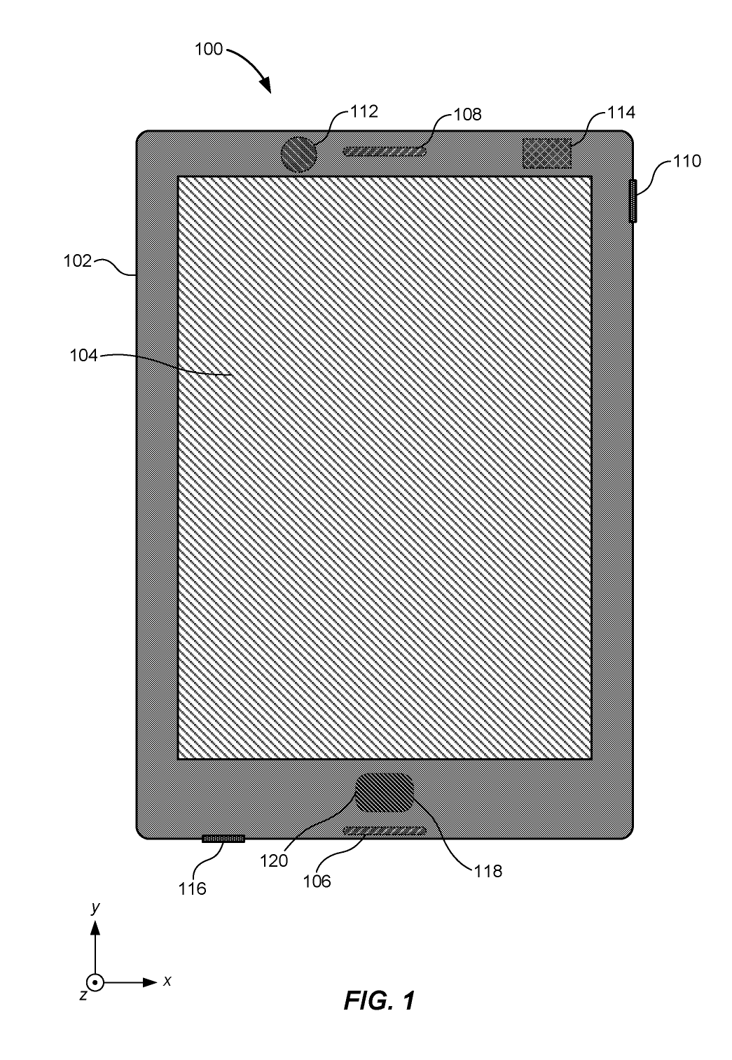

FIG. 1 shows a diagrammatic representation of an example mobile device 100 that includes a capacitive touch sensor according to some implementations. In the example of FIG. 1, the mobile device 100 also includes an ultrasonic sensing system. The mobile device 100 may be representative of, for example, various portable computing devices such as cellular phones, smartphones, multimedia devices, personal gaming devices, tablet computers and laptop computers, among other types of portable computing devices. However, various implementations described herein are not limited in application to portable computing devices. Indeed, various techniques and principles disclosed herein may be applied in traditionally non-portable devices and systems, such as in computer monitors, television displays, kiosks, vehicle navigation devices and audio systems, among other applications. Additionally, various implementations described herein are not limited in application to devices that include displays.

The mobile device 100 generally includes a housing (or “case”) 102 within which various circuits, sensors and other electrical components reside. In the illustrated example implementation, the mobile device 100 also includes a touchscreen display (also referred to herein as a “touch-sensitive display”) 104. The touchscreen display 104 generally includes a display and a touchscreen arranged over or otherwise incorporated into or integrated with the display. The touchscreen display 104 may generally be representative of any of a variety of suitable display types that employ any of a variety of suitable display technologies. For example, the touchscreen display 104 may be a digital micro-shutter (DMS)-based display, a light-emitting diode (LED) display, an organic LED (OLED) display, a liquid crystal display (LCD), an LCD display that uses LEDs as backlights, a plasma display, an interferometric modulator (IMOD)-based display, or another type of display suitable for use in conjunction with touch-sensitive user interface (UI) systems.

The mobile device 100 may include various other devices or components for interacting with, or otherwise communicating information to or receiving information from, a user. For example, the mobile device 100 may include one or more microphones 106, one or more speakers 108, and in some cases one or more at least partially mechanical buttons 110. The mobile device 100 may include various other components enabling additional features such as, for example, one or more video or still-image cameras 112, one or more wireless network interfaces 114 (for example, Bluetooth, WiFi or cellular) and one or more non-wireless interfaces 116 (for example, a universal serial bus (USB) interface or an HDMI interface).

The mobile device 100 may include an ultrasonic sensing system 118 capable of scanning and imaging an object signature, such as a fingerprint, palm print or handprint. In some implementations, the ultrasonic sensing system 118 may function as a touch-sensitive control button. In some implementations, a touch-sensitive control button may be implemented with a mechanical or electrical pressure-sensitive system that is positioned under or otherwise integrated with the ultrasonic sensing system 118. In other words, in some implementations, a region occupied by the ultrasonic sensing system 118 may function both as a user input button to control the mobile device 100 as well as a fingerprint sensor to enable security features such as user authentication features.

The mobile device 100 may include a capacitive touch sensor 120 capable of capacitive touch detection of an object, such as a finger or stylus. The capacitive touch sensor is integrated into the seal ring of a chip. In some implementations, the capacitive touch sensor may be implemented on a chip that is part of the ultrasonic sensing system 118. In some implementations, detection of a finger by the capacitive touch sensor may provide low power activation of the mobile device, with the ultrasonic sensing system 118 used for authentication by ultrasonic fingerprint detection.

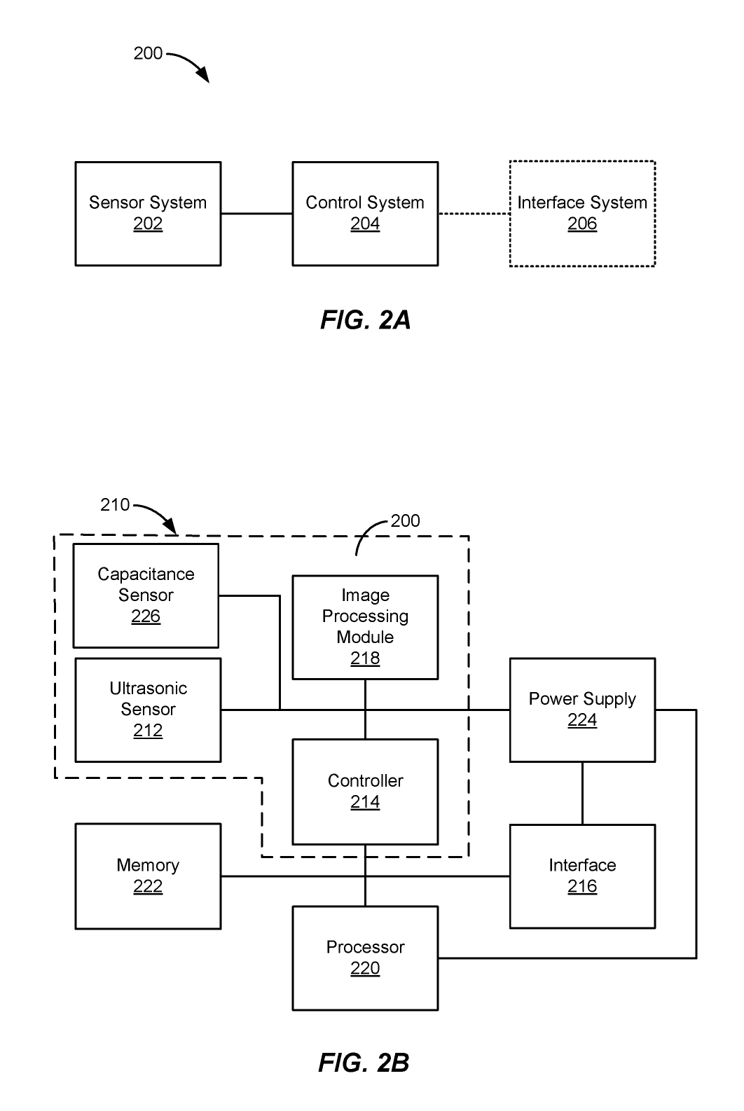

FIG. 2A shows a block diagram representation of components of an example sensing system 200 according to some implementations. As shown, the sensing system 200 may include a sensor system 202 and a control system 204 electrically coupled to the sensor system 202. The sensor system 202 may be capable of detecting capacitance of an object, for example such as a human finger. The sensor system 202 may be capable of scanning an object and providing raw measured image data usable to obtain an object signature, for example, such as a fingerprint of a human finger. The control system 204 may be capable of controlling the sensor system 202 and processing the raw measured image data received from the sensor system. In some implementations, the sensing system 200 may include an interface system 206 capable of transmitting or receiving data, such as raw or processed measured image data, to or from various components within or integrated with the sensing system 200 or, in some implementations, to or from various components, devices or other systems external to the ultrasonic sensing system.

FIG. 2B shows a block diagram representation of components of an example mobile device 210 that includes the sensing system 200 of FIG. 2A. For example, the mobile device 210 may be a block diagram representation of the mobile device 100 shown in and described with reference to FIG. 1 above. The sensor system 202 of the sensing system 200 of the mobile device 210 may be implemented with a capacitive sensor 226 and an ultrasonic sensor 212. The control system 204 of the sensing system 200 may be implemented with a controller 214 that is electrically coupled to the capacitive sensor 226 and the ultrasonic sensor 212. While the controller 214 is shown and described as a single component, in some implementations, the controller 214 may collectively refer to two or more distinct control units or processing units in electrical communication with one another. In some implementations, the controller 214 may include one or more of a general purpose single- or multi-chip processor, a central processing unit (CPU), a digital signal processor (DSP), an applications processor, an application specific integrated circuit (ASIC), a field programmable gate array (FPGA) or other programmable logic device (PLD), discrete gate or transistor logic, discrete hardware components, or any combination thereof designed to perform the functions and operations described herein. In some implementations, the controller 214 is capable of detecting a capacitance using the capacitive sensor 226.

The sensing system 200 of FIG. 2B may include an image processing module 218. In some implementations, raw measured image data provided by the ultrasonic sensor 212 may be sent, transmitted, communicated or otherwise provided to the image processing module 218. The image processing module 218 may include any suitable combination of hardware, firmware and software configured, adapted or otherwise operable to process the image data provided by the ultrasonic sensor 212. In some implementations, the image processing module 218 may include signal or image processing circuits or circuit components including, for example, amplifiers (such as instrumentation amplifiers or buffer amplifiers), analog or digital mixers or multipliers, switches, analog-to-digital converters (ADCs), passive or active analog filters, among others. In some implementations, one or more of such circuits or circuit components may be integrated within the controller 214, for example, where the controller 214 is implemented as a system-on-chip (SoC) or system-in-package (SIP). In some implementations, one or more of such circuits or circuit components may be integrated within a DSP included within or coupled to the controller 214. In some implementations, the image processing module 218 may be implemented at least partially via software. For example, one or more functions of, or operations performed by, one or more of the circuits or circuit components just described may instead be performed by one or more software modules executing, for example, in a processing unit of the controller 214 (such as in a general purpose processor or a DSP).

In some implementations, in addition to the sensing system 200, the mobile device 210 may include a separate processor 220, a memory 222, an interface 216 and a power supply 224. In some implementations, the controller 214 of the sensing system 200 may control the capacitive sensor 226, the ultrasonic sensor 212 and the image processing module 218, and the processor 220 of the mobile device 210 may control other components of the mobile device 210. In some implementations, the processor 220 communicates data to the controller 214 including, for example, instructions or commands. In some such implementations, the controller 214 may communicate data to the processor 220 including, for example, raw or processed image data. It should also be understood that, in some other implementations, the functionality of the controller 214 may be implemented entirely, or at least partially, by the processor 220. In some such implementations, a separate controller 214 for the sensing system 200 may not be required because the functions of the controller 214 may be performed by the processor 220 of the mobile device 210.

Depending on the implementation, one or both of the controller 214 and processor 220 may store data in the memory 222. For example, the data stored in the memory 222 may include raw measured image data, filtered or otherwise processed image data, estimated PSF or estimated image data, and final refined PSF or final refined image data. The memory 222 may store processor-executable code or other executable computer-readable instructions capable of execution by one or both of the controller 214 and the processor 220 to perform various operations (or to cause other components such as the ultrasonic sensor 212, the image processing module 218, or other modules to perform operations), including any of the calculations, computations, estimations or other determinations described herein (including those presented in any of the equations below). It should also be understood that the memory 222 may collectively refer to one or more memory devices (or “components”). For example, depending on the implementation, the controller 214 may have access to and store data in a different memory device than the processor 220. In some implementations, one or more of the memory components may be implemented as a NOR- or NAND-based Flash memory array. In some other implementations, one or more of the memory components may be implemented as a different type of non-volatile memory. Additionally, in some implementations, one or more of the memory components may include a volatile memory array such as, for example, a type of RAM.

In some implementations, the controller 214 or the processor 220 may communicate data stored in the memory 222 or data received directly from the image processing module 218 through an interface 216. For example, such communicated data can include image data or data derived or otherwise determined from image data. The interface 216 may collectively refer to one or more interfaces of one or more various types. In some implementations, the interface 216 may include a memory interface for receiving data from or storing data to an external memory such as a removable memory device. Additionally or alternatively, the interface 216 may include one or more wireless network interfaces or one or more wired network interfaces enabling the transfer of raw or processed data to, as well as the reception of data from, an external computing device, system or server.

A power supply 224 may provide power to some or all of the components in the mobile device 210. The power supply 224 may include one or more of a variety of energy storage devices. For example, the power supply 224 may include a rechargeable battery, such as a nickel-cadmium battery or a lithium-ion battery. Additionally or alternatively, the power supply 224 may include one or more supercapacitors. In some implementations, the power supply 224 may be chargeable (or “rechargeable”) using power accessed from, for example, a wall socket (or “outlet”) or a photovoltaic device (or “solar cell” or “solar cell array”) integrated with the mobile device 210. Additionally or alternatively, the power supply 224 may be wirelessly chargeable.

As used hereinafter, the term “processing unit” refers to any combination of one or more of a controller of an ultrasonic system (for example, the controller 214), an image processing module (for example, the image processing module 218), or a separate processor of a device that includes the ultrasonic system (for example, the processor 220). In other words, operations that are described below as being performed by or using a processing unit may be performed by one or more of a controller of the ultrasonic system, an image processing module, or a separate processor of a device that includes the ultrasonic sensing system.

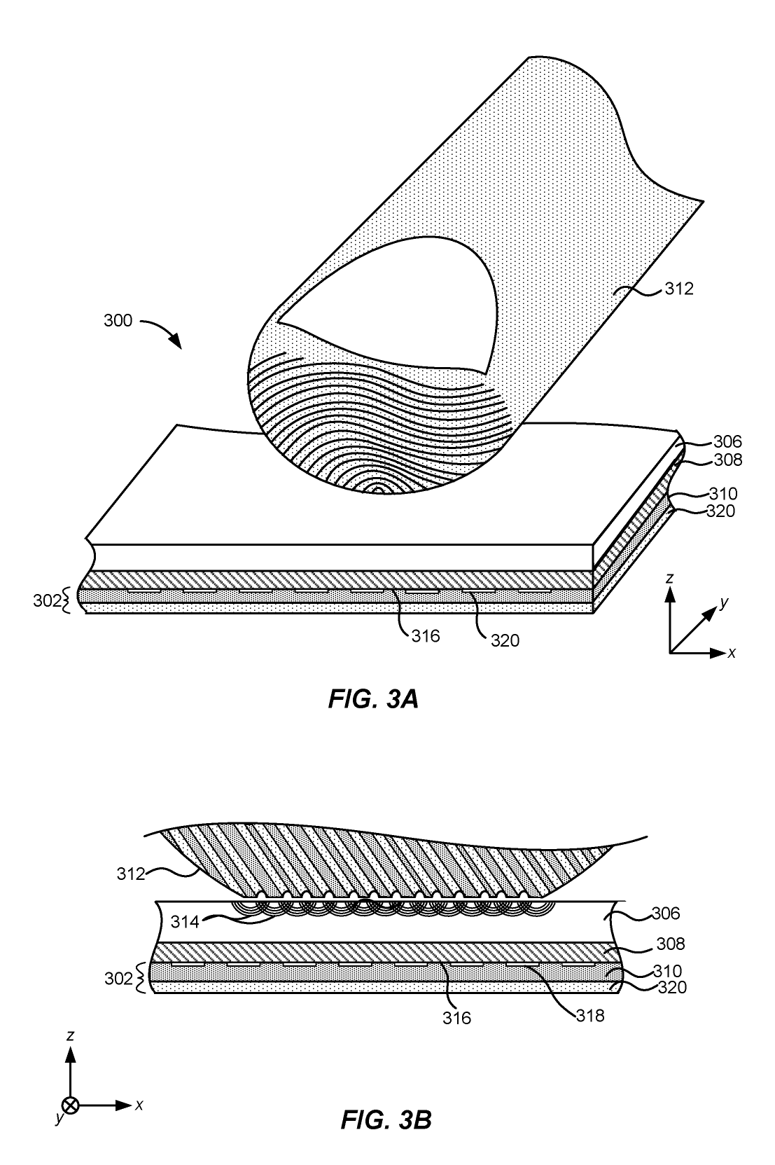

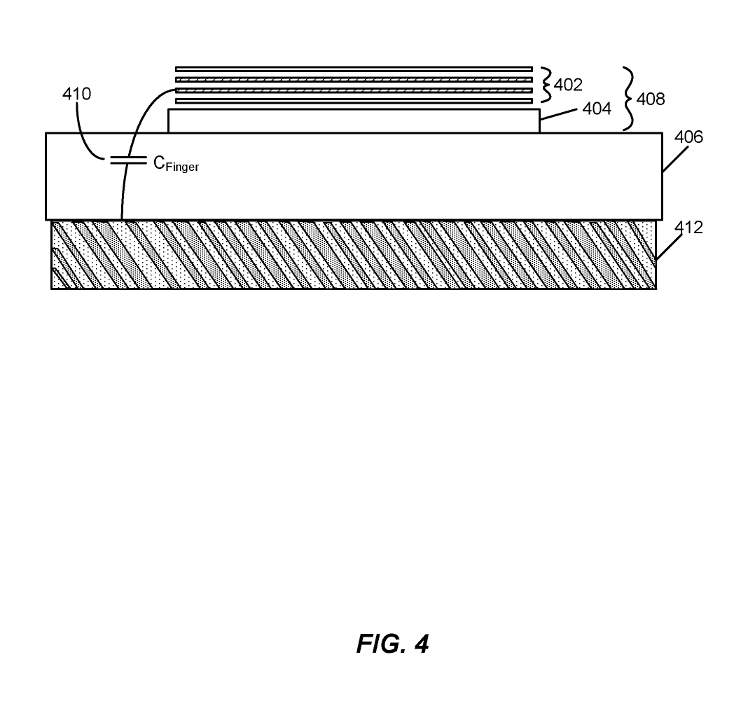

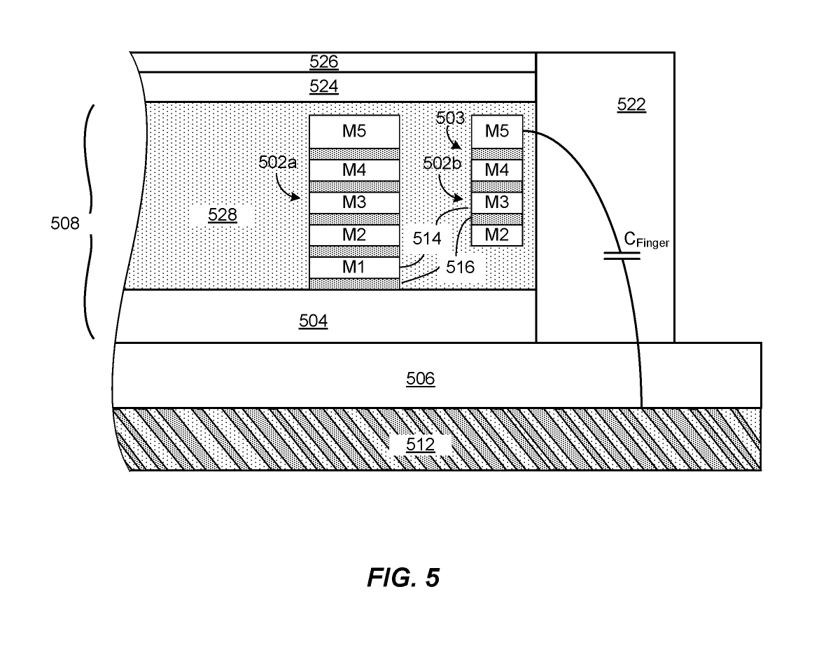

FIG. 3A shows a cross-sectional projection view of a diagrammatic representation of a portion of an example sensing system 300 according to some implementations. FIG. 3B shows a zoomed-in cross-sectional side view of the example sensing system 300 of FIG. 3A according to some implementations. For example, the sensing system 300 may implement the capacitive touch sensor 120 and the ultrasonic sensing system 118 described with reference to FIG. 1 or the sensing system 200 shown and described with reference to FIGS. 2A and 2B. The sensing system 300 may include a chip 308 that underlies a platen (which may be referred to as a “cover plate” or “cover glass”) 306. In FIGS. 3A and 3B and subsequent figures, the relative dimensions of the elements of the figures are not shown to scale for ease of illustration.

The chip 308 includes a capacitive sense plate (not shown) formed on a surface 316 of a substrate of the chip that is opposite the platen 306. The chip 308 may be a silicon (Si) chip and includes an integrated circuit. In the example of FIG. 3, the chip 308 may be a sensor chip configured, for example, to detect ultrasonic reflections 314 resulting from interactions of ultrasonic waves with ridges and valleys defining the fingerprint of a finger 312 being scanned. The capacitive sense plate may be integrated with a seal ring of the chip 308.

In the example of FIGS. 3A and 3B, the sensing system 300 may also include an ultrasonic transmitter 302. It is understood that the presence of components such as the ultrasonic transmitter 302 depends on the particular sensing system employed and that a chip including a capacitive sense plate integrated with a seal ring of the chip may be employed with any appropriate sensing system. In the example of FIGS. 3A and 3B, the ultrasonic transmitter 302 is generally configured to generate ultrasonic waves towards the platen 306, and in the illustrated implementation, towards the finger 312 positioned on the upper surface of the platen. In some implementations, the ultrasonic transmitter 302 may more specifically be configured to generate ultrasonic plane waves towards the platen 306. In some implementations, the ultrasonic transmitter 302 further includes first transmitter electrode 318, second transmitter electrode 320, and a layer of piezoelectric material 310 such as, for example, polyvinylidene fluoride (PVDF) or a PVDF copolymer such as PVDF-trifluoroethylene (TrFE). For example, the layer of piezoelectric material 310 of the ultrasonic transmitter 302 may be configured to convert electrical signals provided by the controller of the sensing system into a continuous or pulsed sequence of ultrasonic plane waves at a scanning frequency. As a result of the piezoelectric effect, the applied transmitter excitation voltage causes changes in the thickness of the layer of piezoelectric material 310, and in such a fashion, generates ultrasonic waves at the frequency of the transmitter excitation voltage. The ultrasonic waves may travel towards a target object, such as the finger 312, passing through the platen 306. A portion of the ultrasonic waves not absorbed or transmitted by the target object may be reflected back through the platen 306 and received by a sensor, which in the example of FIGS. 3A and 3B includes the chip 308.

The platen 306 may be formed of any suitable material. In implementations that include an ultrasonic transmitter, it may be formed of any material that may be acoustically coupled to the ultrasonic transmitter 302. For example, the platen 306 may be formed of one or more of glass, plastic, ceramic, sapphire, metal or metal alloy. In some implementations, the platen 306 may be a cover plate such as, for example, a cover glass or a lens glass of an underlying display. In some implementations, the platen 306 may include one or more polymers, such as one or more types of parylene, and may be substantially thinner. In some implementations, the platen 306 may have a thickness in the range of about 10 microns (μm) to about 1000 μm or more. In some examples, the platen 306 may have a thickness between 300 μm to 700 μm, for example 400 μm.

In some implementations disclosed herein, capacitive touch sensing may be integrated with another sensor such as the ultrasonic fingerprint sensor described with reference to FIGS. 3A and 3B. A capacitance between the capacitive sense plate formed on the surface 316 of a substrate of the chip 308 and the finger 312 may be detected and used, for example, to detect the presence of a finger prior to fingerprint imaging by the ultrasonic fingerprint sensor.

Capacitive touch detection in a device may typically employ measurement of the capacitance that exists between parallel plate conductors, which may be referred to as parallel plate or direct capacitance. For example, a metal electrode layer in a stack may act as a capacitive sense plate, with the direct capacitance between the metal electrode layer and a finger measured.

In some implementations, a chip, such a Si chip, may electrically shield a capacitive sense plate from a finger, such that a direct capacitance between the capacitive sense plate and the finger cannot be measured. A fringe capacitance, which also may be referred to as an edge capacitance, is detected. The unshielded portion of the finger and the chip are laterally displaced from one another, such that it is the fringes of the capacitive conductors that predominantly contribute to their capacitance.

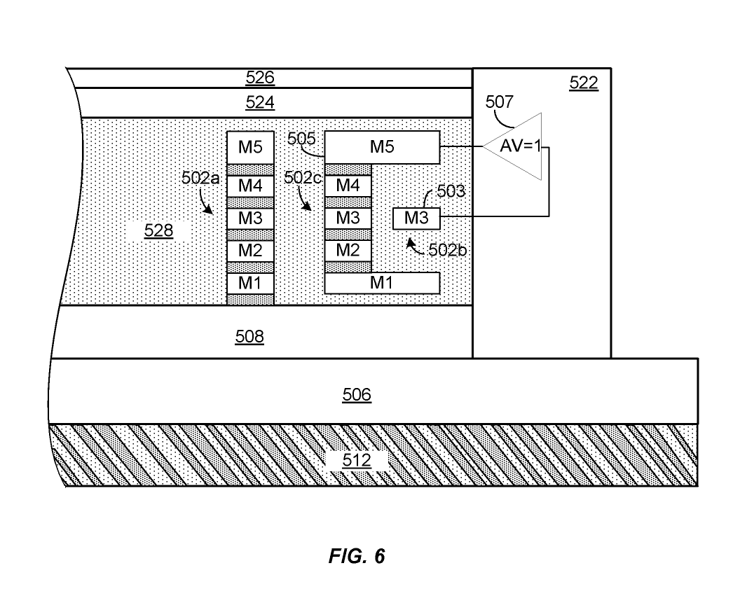

FIG. 4 shows an example of a device including a fingerprint sensor capable of capacitive sensing. In particular, the fingerprint sensor includes a Si sensor chip 408. The Si sensor chip 408 includes a chip substrate 404 and a chip seal ring 402 that includes a capacitive sense plate. The chip seal ring 402 surrounds an active circuit region (not shown). The Si sensor chip 408 may be configured to image a fingerprint of a finger 412 that is placed on a platen 406. In some implementations, the Si sensor chip 408 may include an ultrasonic fingerprint sensor as described above with respect to FIGS. 1-3B. In other implementations, other types of fingerprint sensors may be employed including optical sensors. The chip substrate 404 acts a shield, such that there is no direct capacitance between the finger 412 and electrodes on the opposite side of the Si sensor chip 408 to be measured for capacitive touch detection. In operation, a fringe capacitance of the finger to the seal ring, C_{Finger}, 410 is detected.

In the example of FIG. 4, the chip seal ring 402 is on a surface of the chip substrate 404 that faces away from the platen 406, such that the chip substrate 404 acts as a shield between the platen 406 and the chip seal ring 402. In some other implementations, the Si sensor chip 408 may be arranged such that the chip seal ring 402 is on a surface that faces toward the platen 406. In such cases, if the chip seal ring 402 is not otherwise shielded, a direct capacitance rather than a fringe capacitance predominantly contribute to a measured capacitance used for capacitive touch detection.

A chip, such as the Si sensor chip 408 in FIG. 4, will include a chip substrate having a seal ring region that surrounds an active circuit region. The chip substrate is typically a semiconductor material such as silicon, silicon-on-insulator (SOI), gallium arsenide (GaAs), gallium nitride (GaN), and the like. A seal ring is disposed in the seal ring region, between the core circuitry in the active circuit region and the edges of the chip, to protect the core circuitry. For example, a seal ring may prevent cracks introduced during chip dicing or packaging from reaching the core circuitry. A seal ring may also provide moisture protection. A seal ring generally includes one or more layers of metal and dielectric materials forming a structure that surrounds the core circuitry of the chip. A seal ring may be formed on the chip during fabrication of the core circuitry. While the chips described herein are sensor chips, the chip rings having integrated capacitive sense rings may be employed with any type of integrated circuit chip.

As indicated above, the seal rings disclosed herein have an incorporated capacitive sense plate. In some implementations, one or more metallization layers of a seal ring structure may be a capacitive sense plate used to detect a fringe capacitance between the capacitive sense plate and a finger. In some implementations, a seal ring includes multiple concentric rings, including a grounded inner ring and an outer ring that includes a capacitive sense plate. FIG. 5 shows a cross-sectional schematic of an example of a portion of a device including a sensor chip seal ring having concentric rings. In the example of FIG. 5, the sensor includes a platen 506, a Si sensor chip 508, a chip substrate 504, and a seal ring that includes an inner ring 502a and an outer ring 502b. The inner ring 502a and the outer ring 502b surround an active circuit region (not shown) of the Si sensor chip 508.

Each ring includes metallization layers 514 (labeled M1-M5). The inner ring 502a and the outer ring 502b of the seal ring are embedded within a dielectric material 528. In the example of FIG. 5, the metallization layers 514 are separated by dielectric layers 516, which may be the same material as dielectric material 528 or a different dielectric material. In some implementations, the metallization layers 514 may be electrically connected by via interconnects (not shown) that extend through the dielectric layers 516. In some implementations, one or more of the metallization layers 514 may be formed directly on top of the underlying metallization layer with no interposed dielectric layer.

Additional layers 524 and 526 may be formed on top of the dielectric material 528. Each of the additional layers 524 and 526 may be any of an additional component of the sensor stack, for example, part of an ultrasonic transmitter as discussed above with respect to FIGS. 3A and 3B, a passivation layer of the Si sensor chip 508, or other component of an apparatus. An epoxy 522 or other dielectric packaging material may be provided on the side of the Si sensor chip 508.

The inner ring 502a of the seal ring may provide protection against crack propagation and moisture intrusion and may be electrically grounded. The outer ring 502b may include an electrically floating capacitive sense plate 503; in the example of FIG. 5, the capacitive sense plate 503 is formed by metallization layers M2-M5 of the outer ring 502b. In operation, a fringe capacitance C_{Finger} between the capacitive sense plate 503 and a finger 512 is detected. In some implementations, the chip substrate 504 is grounded and the inner ring 502a is electrically connected to the chip substrate 504, with the metal layer M1 in direct physical contact with or connected by a via interconnect or other connection to the chip substrate 504. By contrast, the outer ring 502b may be electrically isolated from the chip substrate 504, separated for example, by the dielectric material 528.

According to various implementations, the outer ring 502b may or may not provide protection to the active circuit region. In the example of FIG. 5, the outer ring 502b includes a subset of the metallization layers 514 that are present in the inner ring 502a. Specifically, the outer ring 502b includes four (M2-M5) of the five (M1-M5) metallization layers present in the inner ring 502a. By using the same metallization for the outer ring 502b as for the inner ring 502a, the capacitive sense plate 503 may be fabricated as part of the seal ring fabrication process. However, in some implementations, the outer ring 502b may include different metals or patterned layers than present in the inner ring 502a.

In some implementations, the seal ring may further include an active shield to reduce background capacitance. The active shield is spaced apart from the capacitive sense plate and may be driven with a unity gain (AV=1) amplifier to maintain a constant potential difference between the capacitive sense plate and the active shield. FIG. 6 shows a cross-sectional schematic of an example of a portion of a device including a sensor chip seal ring including a capacitive sense plate and an active shield. In FIG. 6, a seal ring includes three concentric rings: an inner ring 502a, an outer ring 502b, and an intermediate ring 502c. In the example of FIG. 6, the active shield is formed by the metallization layers M1-M5 of the intermediate ring 502c and the capacitive sense plate 503 is formed by the metallization layer M3 of the outer ring 502b. A unity gain amplifier 507 is connected between the capacitive sense plate 503 and the active shield 505. The active shield 505 may reduce the background capacitance, improving the sensitivity of the sensor.

As with the outer ring 502b, by using the same metallization for the intermediate ring 502c as for the inner ring 502a, the active shield 505 may be fabricated as part of the seal ring fabrication process. However, in some implementations, the intermediate ring 502c may include different metals or patterned layers than present in the inner ring 502a. Also, as with the outer ring 502b, the intermediate ring 502c is electrically isolated from the chip substrate 504.

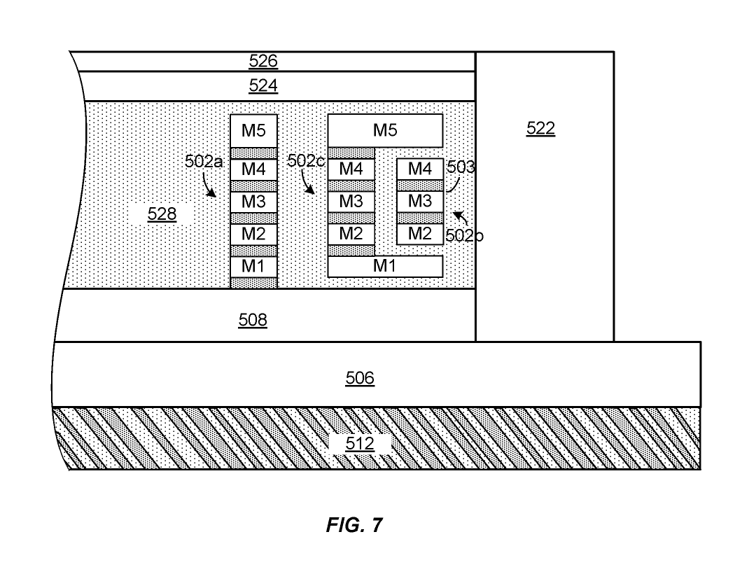

A seal ring including an active shield may be implemented by various arrangements. As noted above, in some implementations, a seal ring may include three concentric rings: an inner ring to provide protection against crack propagation, an outer ring including a capacitive sense plate, and an intermediate ring including an active shield. The placement and size of the active shield may depend on the placement of likely sources of background capacitance according to the particular sensor arrangement. FIGS. 7-9 show examples of various arrangements of a sensor chip seal ring including a capacitive sense plate and an active shield.

In the example of FIG. 7, the active shield is formed by the metallization layers M1-M5 of the intermediate ring 502c and the capacitive sense plate 503 is formed by the metallization layers M2-M4 of the outer ring 502b. An amplifier connected between the capacitive sense plate 503 and the active shield 505 is not shown for ease of illustration. The arrangement shown in FIG. 7 is similar to that shown in FIG. 6, with the capacitive sense plate 503 in FIG. 7 being larger than that in FIG. 6.

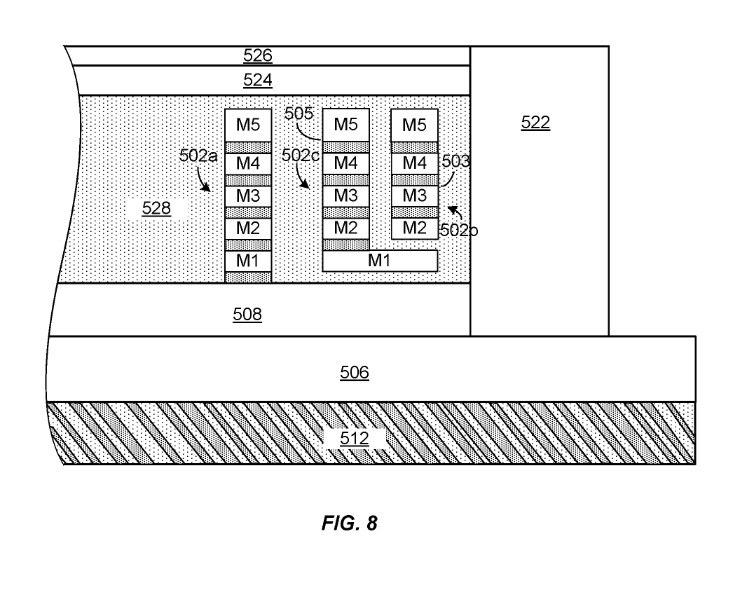

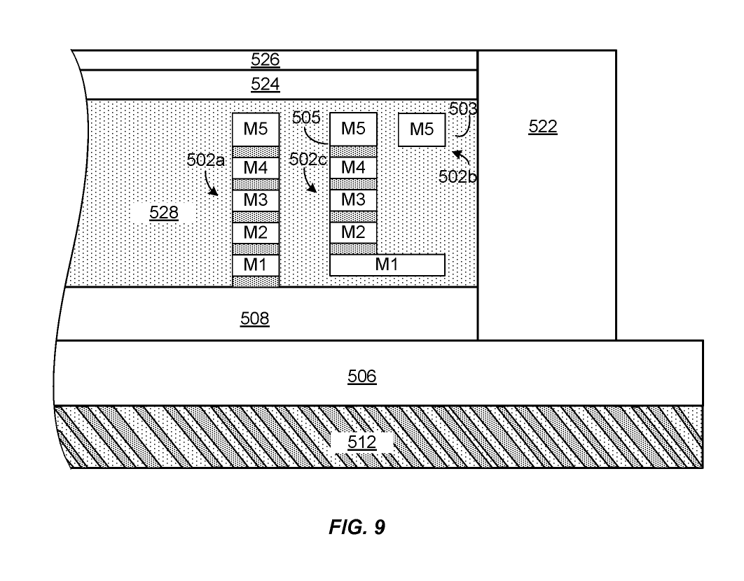

In the example of FIG. 8, the active shield is formed by the metallization layers M1-M5 of the intermediate ring 502c and the capacitive sense plate 503 is formed by the metallization layers M2-M5 of the intermediate ring 502c. An amplifier connected between the capacitive sense plate 503 and the active shield 505 is not shown for ease of illustration.

In the examples of FIGS. 6 and 7, the active shield 505 forms a C-shape around the capacitive sense plate 503, shielding it from interference from above and below it as well as from the direction of the active circuit region. In the example of FIG. 8, the active shield 505 forms an L-shape around the capacitive sense plate 503, shielding the capacitive sense plate 503 from interference from the directions of the Si sensor chip 508 and the active circuit region, but not from the direction of the layers 524 and 526. The example of FIG. 9 is similar to that of FIG. 8, with the capacitive sense plate 503 being formed only by layer M5 of the outer ring 502b.

While examples of seal ring structures are provided in FIGS. 5-9, other seal ring structures may be employed. For example, there may be one or more additional rings between the outer ring and the active circuit ring to provide additional protection to the active circuit region. There also may be any appropriate number of metallization.

The concentric rings of the seal ring may be any appropriate shape, including rectangular, square, circular, and the like. The term concentric as used herein refers to sharing a common center as measured from the innermost wall of the ring. As can be seen from the examples of FIGS. 6-9, the width of the metallization layers of a ring may vary according to the particular design. As an example, in FIG. 7, the M1 and M5 layers of the intermediate ring 502c are wider than that of the M2-M4 layers to provide shielding. The concentric rings are spaced apart by an insulative material. Multiple metallization layers of a capacitive sense plate are generally electrically connected by via interconnects between the layers or by being in direct physical contact with no interposed dielectric layers. Similarly, multiple metallization layers of an active shield are generally electrically connected by via interconnects between the layers or by being in direct physical contact with no interposed dielectric layers.

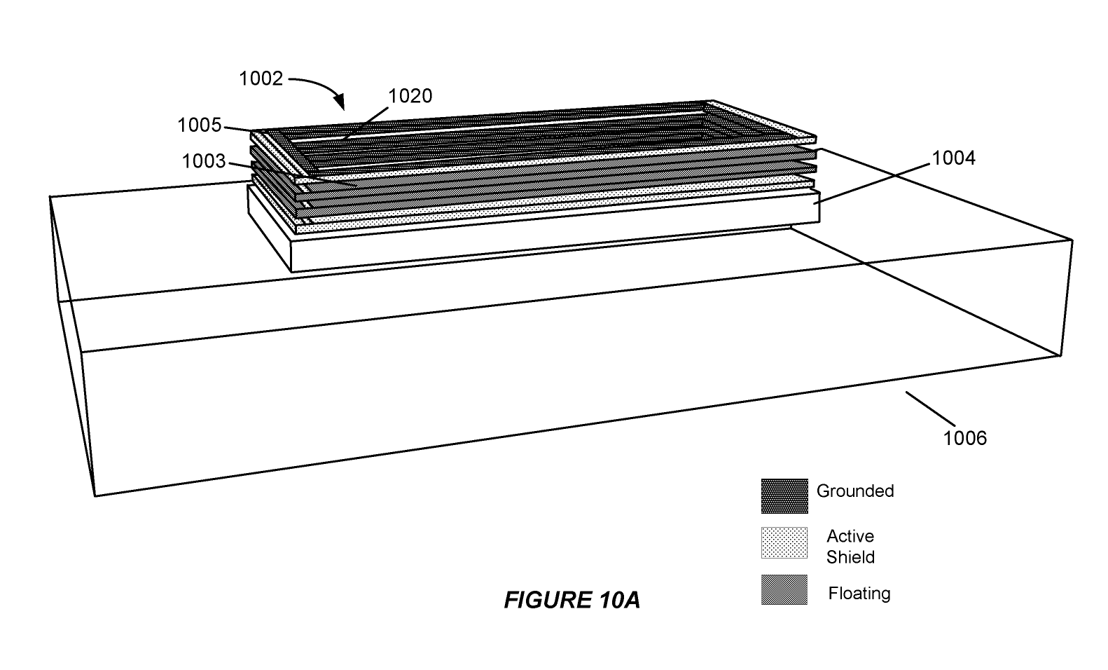

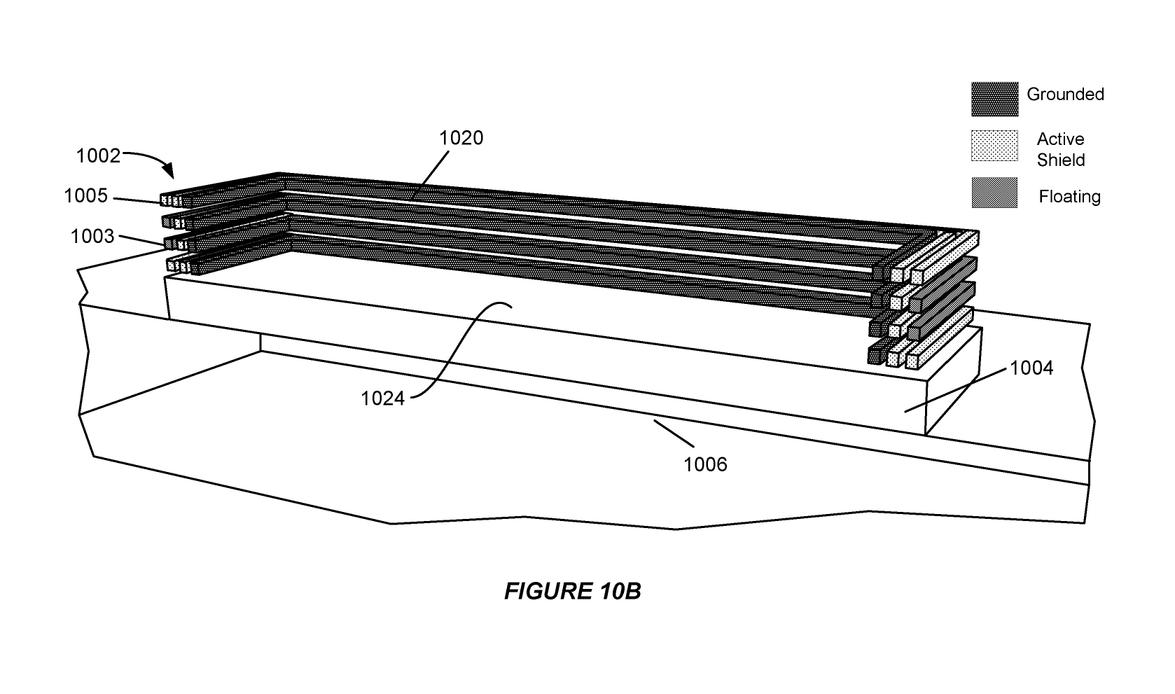

FIGS. 10A and 10B show an example of a sensor including a platen 1006, a Si sensor chip substrate 1004, and a seal ring 1002. The seal ring 1002 is a generally rectangular shape and includes three concentric rings of lines of M1-M4 metallization layers. The dark grey lines 1020 are electrically grounded, the light grey lines 1005 form an active shield, and the medium grey lines 1003 form an electrically floating capacitive sense plate. The Si sensor chip substrate 1004 is electrically grounded. A cross-sectional depiction of the sensor is shown in FIG. 10B, which also depicts an active circuit region 1024 that is surrounded by the seal ring 1002. As described above, the medium grey lines 1003 of the electrically floating capacitive sense plate may be electrically connected by via interconnects (not shown) or by being in direct physical contact. The electrically grounded dark grey lines of the inner seal ring are generally electrically connected to each other as are the light grey lines of the active shield.

As discussed above, an amplifier may be connected between a capacitive sense plate and an active shield incorporated into a seal ring. While a unity gain buffer is depicted in the example of FIG. 6, various types of amplifiers may be used to implement a buffer such as an operational amplifier. The buffer can be a part of electronic circuit incorporated into the chip and can be manufactured with the rest of the on-chip circuitry,

Metallization layers, and the via interconnect layers if present, of a seal ring may be any appropriate metal including aluminum (Al), Al alloys, copper (Cu), Cu alloys, and combinations thereof.

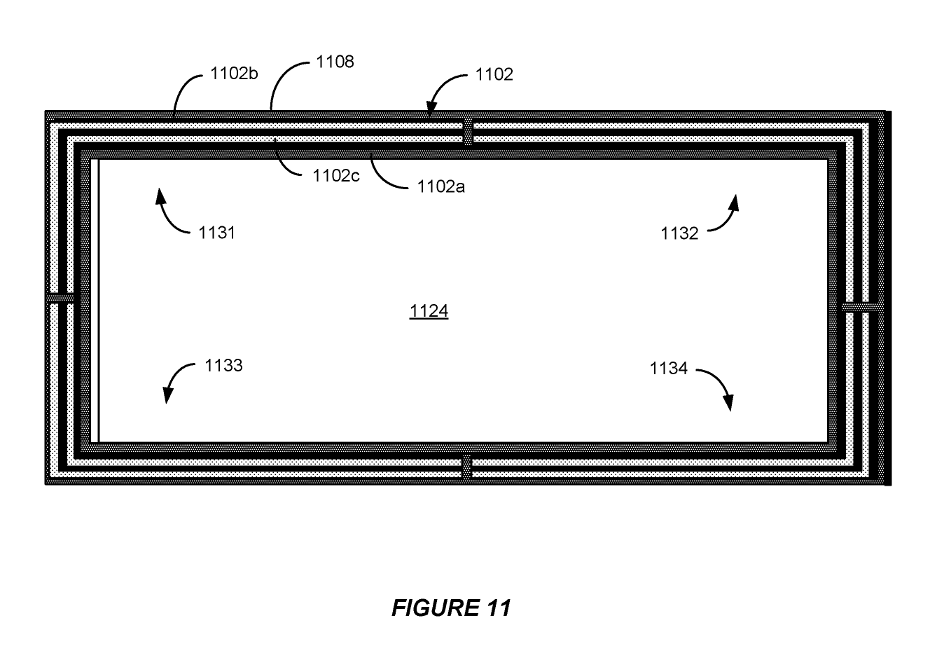

In some implementations, one or more the concentric rings of a seal ring described herein can be segmented to detect a touch location. In such implementations, an inner ring may not be segmented to provide protection without break around the entire active circuit region. An outer ring that includes a capacitive sense plate and an intermediate ring that includes an active shield, if present, may be segmented to provide multiple capacitive sense plates and active shields. FIG. 11 shows an example of a top view of a seal ring including a segmented outer ring and a segmented intermediate ring. The seal ring 1102 is formed on a surface of a Si sensor chip 1108 and surrounds an active circuit region 1124. The seal ring includes three concentric rings: inner ring 1102a, outer ring 1102b, and intermediate ring 1102c. The inner ring 1102a is an electrically grounded, unsegmented ring that provides protection against one or more of crack propagation and moisture intrusion. The outer ring 1102b in an electrically floated, segmented ring that includes a capacitive sense plate. The intermediate ring 1102c includes an active shield and is also segmented, with the segments corresponding to those of the outer ring 1102b. In the example of FIG. 11, the outer ring 1102b and the intermediate ring 1102c are segmented into four segments 1131, 1132, 1133, and 1134. Each segment includes a capacitive sense plate and is electrically isolated from the other segments, such that a capacitance between the capacitive sense plate of each segment and a finger can be independently measured. In this manner, information about the location of a finger may be obtained. In one example, the Si sensor chip 1108 may underlay a home button of a mobile phone or other electronic device. If, in use, capacitance is detected only with the capacitive sense plate of segment 1134, it may indicate an accidental touch to be rejected. In some implementations, the individual segments may be used to implement a navigation feature for a home button or other area of a device.

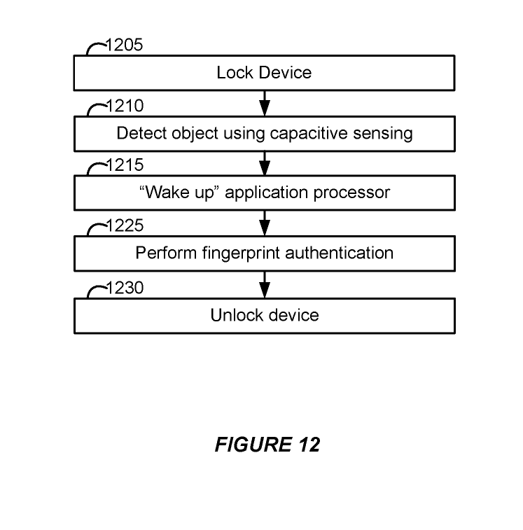

As indicated above, the sensing systems described herein may be used as a wake-up mechanism for an electronic device. FIG. 12 shows an example of a flowchart for using a capacitive touch sensor to wake up an electronic device. In FIG. 12, at block 1205, an electronic device may be in a “locked” state in which an applications processor and display of the electronic device are turned off or are in a relatively low power “sleep” mode. In example, the touchscreen display 104 of the mobile device 100 in FIG. 1 may be turned off such that no visual image content is being displayed. An applications processor such as the processor 220 in FIG. 2b may be in a relatively low power sleep mode.

Next, at block 1210, an object may be detected using capacitive sensing. For example, in FIG. 4, the finger 412 has just been placed upon a platen 406. The finger capacitance can be measured using any standard capacitive sensing mechanism. For example an oscillator circuit may be employed, with the finger capacitance calculated by measuring the oscillator frequency or charging time to reach a threshold voltage. Other appropriate circuits and techniques for measuring capacitance may also be employed. As described above with respect to FIG. 11, in some implementations, out-of-bound touches may be rejected.

If an object is determined to have touched the platen 406 (e.g., based on a read-out voltage), then at block 1215, a controller may “wake up” an applications processor. For example, in FIG. 2B, an applications processor 220 may be activated (or triggered, initialized, etc.) from a sleep mode or off state by controller 214. In some implementations, a controller or applications processor may also turn on a display.

Next, at block 1225, fingerprint authentication may be performed. In some implementations, if ultrasonic fingerprint imaging is to be used, a controller may configure a sensor to transmit and receive ultrasonic waves as discussed above with respect to FIGS. 3A and 3B, to provide data corresponding with a full or partial fingerprint image of the finger.

An applications processor, such as the applications processor 220, may obtain the fingerprint image data (e.g., by receiving the corresponding data stored in memory by the controller) and then determine whether the fingerprint image data represents a fingerprint of an authorized fingerprint. If so, then at block 1230, the device may be unlocked with most of the full operating functionality and software of the device available for use. The image data for the authorized fingerprint may have been provided previously by the user for example, during the setup of electronic device or setup of the security features of the electronic device.

Various modifications may be made to the method depicted in the flowchart of FIG. 12. For example, in some implementations, object imaging may be employed after detection of an object using capacitive sensing in block 1210 and prior to waking up an applications processor in block 1215. Only if the object is determined to be a finger (e.g., because it has ridges and valleys or other characteristics of a fingerprint belonging to a finger), does the method proceed to waking up an applications processor in block 1215. The fingerprint authentication may then use the image obtained in the earlier operation. Further, in some implementations, detection of an objection using capacitive sensing (as in block 1210) may be used to determine if the finger is centered on a button of the electronic device for ultrasonic operation. As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification may be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium, such as a non-transitory medium. The processes of a method or algorithm disclosed herein may be implemented in a processor-executable software module that may reside on a computer-readable medium. Computer-readable media include both computer storage media and communication media including any medium that may be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those having ordinary skill in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein, if at all, to mean “serving as an example, instance, or illustration.” Any implementation described herein as “exemplary” is not necessarily to be construed as preferred or advantageous over other implementations.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

It will be understood that unless features in any of the particular described implementations are expressly identified as incompatible with one another or the surrounding context implies that they are mutually exclusive and not readily combinable in a complementary and/or supportive sense, the totality of this disclosure contemplates and envisions that specific features of those complementary implementations may be selectively combined to provide one or more comprehensive, but slightly different, technical solutions. It will therefore be further appreciated that the above description has been given by way of example only and that modifications in detail may be made within the scope of this disclosure.

What is claimed is:

1. A device comprising:
a platen;
a chip, the chip including:
a chip substrate including a first surface, the first surface including a seal ring region and an active circuit region;
a seal ring on the seal ring region, the seal ring surrounding the active circuit region and including an inner ring and an outer ring, wherein the inner ring is electrically grounded, and wherein the outer ring is electrically floating and includes a capacitive sense plate.

2. The device of claim 1, further comprising a controller configured to detect a capacitance between a finger on the platen and the capacitive sense plate.

3. The device of claim 1, wherein the first surface faces away from the platen.

4. The device of claim 2, wherein the capacitance is a fringe capacitance.

5. The device of claim 1, wherein the seal ring further includes an intermediate ring disposed between the inner ring and the outer ring, wherein the intermediate ring is configured to provide an active shield to the capacitive sense plate.

6. The device of claim 5, further comprising an amplifier connected between the outer ring and the intermediate ring.

7. The device of claim 6, wherein the amplifier is a unity gain amplifier.

8. The device of claim 5, wherein the intermediate ring forms a C-shape around the outer ring.

9. The device of claim 5, wherein the intermediate ring forms an L-shape around the outer ring.

10. The device of claim 1, wherein the chip includes circuitry configured for imaging of a fingerprint.

11. The device of claim 10, wherein the chip includes circuitry configured for ultrasonic imaging of a fingerprint.

12. The device of claim 1, further comprising an ultrasonic transmitter disposed such that the chip is between the ultrasonic transmitter and the platen.

13. The device of claim 1, wherein the outer ring is divided into a plurality of segments electrically isolated from each other and wherein each of the plurality of segments includes a capacitive sense plate.

14. The device of claim 13, further comprising an intermediate ring disposed between the inner ring and the outer ring, wherein the intermediate ring is divided into a plurality of segments electrically isolated from each other and wherein each of the plurality of segments of the intermediate ring is configured to provide an active shield to a capacitive sense plate of the outer ring.

15. The device of claim 2, wherein the controller is further configured to initiate an applications processor to obtain a fingerprint of the finger after the finger is detected.

16. The device of claim 1, wherein the first surface faces toward the platen.

17. The device of claim 2, wherein the capacitance is a direct capacitance.

18. A method:
providing a device including:
a platen;
a chip, the chip including:
a chip substrate including a first surface, the first surface including a seal ring region and an active circuit region, and
a seal ring on the seal ring region, the seal ring surrounding the active circuit region and including an inner ring and an outer ring, wherein the inner ring is electrically grounded, and wherein the outer ring is electrically floating and includes a capacitive sense plate;
detecting a capacitance between a finger on the platen and the capacitive sense plate;
determining that a finger has touched the platen based on the detected capacitance; and
initializing an applications processor based on the determination.

19. The method of claim 18, wherein the first surface faces away from the platen.

20. The method of claim 18, wherein the seal ring further includes an intermediate ring disposed between the inner ring and the outer ring, wherein the intermediate ring is configured to provide an active shield to the capacitive sense plate.

21. The method of claim 18, further comprising authenticating a fingerprint of the finger.

22. A system comprising:
a platen;
a chip including a chip substrate including a first surface, the first surface including a seal ring region and an active circuit region, and a seal ring on the seal ring region, the seal ring surrounding the active circuit region and including an inner ring and an outer ring, wherein the inner ring is electrically grounded, and wherein the outer ring is electrically floating and includes a capacitive sense plate; and
a non-transitory computer readable medium storing instructions executable by one or more processors of a controller, the instructions including:
instructions for detecting a capacitance between a finger on the platen and the capacitive sense plate;
instructions for determining that a finger has touched the platen based on the detected capacitance; and
instructions for initializing an applications processor based on the determination.

23. The system of claim 22, wherein the seal ring further includes an intermediate ring disposed between the inner ring and the outer ring, wherein the intermediate ring is configured to provide an active shield to the capacitive sense plate.

24. The system of claim 23, further comprising an amplifier connected between the outer ring and the intermediate ring.

25. The system of claim 24, wherein the amplifier is a unity gain amplifier.

26. The system of claim 22, wherein the instructions further include instructions for sending a drive signal to the active shield to maintain a constant potential difference between the capacitive sense plate and the active shield.

27. A device comprising:
a platen;
a chip, the chip including a chip substrate including a first surface, the first surface including a seal ring region and an active circuit region, and a seal ring on the seal ring region, wherein the seal ring surrounding the active circuit region; and
means for sensing a capacitance between the seal ring and an object on the platen.

28. The device of claim 27, wherein the seal ring includes an inner ring and an outer ring and wherein the means for sensing a capacitance includes a capacitive sense plate formed by the outer ring.

29. The device of claim 28, further comprising means for electrically shielding the capacitive sense plate from electromagnetic interference.

30. The device of claim 29, wherein the means for electrically shielding the capacitive sense plate from electromagnetic interference include an intermediate ring between the outer ring and the inner ring.
